(19) United States
(12) Patent Application Publication
(10) Pub. No.: US 2015/0235646 A1
(43) Pub. Date: Aug. 20, 2015

(54) AUDIO SIGNAL CODING DEVICE AND AUDIO SIGNAL DECODING DEVICE

(71) Applicant: SOCIONEXT INC., Kanagawa (JP)

(72) Inventors: Shunji MIYASAKA, Osaka (JP); Yong Hwee SIM, Singapore (SG)

(21) Appl. No.: 14/700,957

(22) Filed: Apr. 30, 2015

Related U.S. Application Data
(63) Continuation of application No. PCT/JP2013/004450, filed on Jul. 22, 2013.

(30) Foreign Application Priority Data
Oct. 31, 2012 (JP) 2012-240711

(51) Int. Cl. G10L 19/008

(52) U.S. Cl. CPC G10L 19/008

(57) ABSTRACT

An audio signal coding device including: a layered coding unit which codes a low-band signal which is included in an input audio signal and in a frequency band lower than a boundary frequency to generate a coded low-band signal, and codes a high-band signal in a frequency band higher than the boundary frequency to generate a coded high-band signal; and a layer boundary setting unit which sets the boundary frequency to a first frequency if a coding bitrate to be used by the layered coding unit for coding the low-band signal and the high-band signal is a first bitrate, and sets the boundary frequency to a second frequency lower than the first frequency if the coding bitrate is a second bitrate lower than the first bitrate.

### CROSS REFERENCE TO RELATED APPLICATIONS

This is a continuation application of PCT International Application No. PCT/JP2013/004450 filed on Jul. 22, 2013, designating the United States of America, which is based on and claims priority of Japanese Patent Application No. 2012-240711 filed on Oct. 31, 2012. The entire disclosures of the above-identified applications, including the specifications, drawings and claims are incorporated herein by reference in their entirety.

### FIELD

The present disclosure relates to an audio signal coding device which codes an input audio signal to generate a coded audio signal, and an audio signal decoding device which decodes the coded audio signal.

### BACKGROUND

In recent years, systems which distribute audio-video signals through digital networks are widely used. For example, a system, such as YouTube (registered trademark), performs a service which distributes audio-video signals from a server installed at a remote location. Additionally, in recent years, teleconferencing systems which communicate quality audio-video signals has also become popular.

While transmission capacity of a transmission path through which digital signals as such are transmitted is increasing year by year, an amount of transmission of audio-video signals as mentioned above exceeds the increase in the transmission capacity. Due to this, there is an increasing need for compression coding technique on audio-video signals.

For example, the techniques disclosed in Patent Literatures (PTLs) 1 and 2 are known as such compression coding techniques.

The transmission capacity of a transmission path through which the digital signal as mentioned above is transmitted varies from time to time. Thus, when the transmission path is congested, audio-video signals are not transmitted in real time, thereby, in most cases, causing gaps in a reproduced signal. For example, skipping occurs or a screen freezes for a brief moment. A method to solve this problem changes a bitrate in response to the variation in transmission capacity.

### CITATION LIST

### Patent Literature

[PTL 1] U.S. Pat. No. 7,342,880

[PTL 2] Japanese Unexamined Patent Application Publication No. 2009-503559

### SUMMARY

### Technical Problem

In such techniques, it is desired to inhibit degradation of audio quality when the bitrate is lowered.

Thus, an object of the present disclosure is to provide an audio signal coding device and audio signal decoding device which can inhibit the degradation of audio quality when a bitrate is lowered.

### Solution to Problem

An audio signal coding device according to an aspect of the present disclosure includes: a layered coding unit configured to code a low-band signal in a first frequency band lower than a boundary frequency to generate a coded low-band signal, and code a high-band signal in a second frequency band higher than the boundary frequency to generate a coded high-band signal, the low-band signal and the high-band signal being included in an input audio signal; a layer boundary setting unit configured to determine a coding bitrate to be used by the layered coding unit for coding the low-band signal and the high-band signal, set the boundary frequency to a first frequency if the coding bitrate is a first bitrate, and set the boundary frequency to a second frequency lower than the first frequency if the coding bitrate is a second bitrate lower than the first bitrate; and a multiplexer unit configured to multiplex the coded low-band signal, the coded high-band signal, and boundary information indicative of the boundary frequency to generate a coded audio signal.

According to the above configuration, the audio signal coding device can broaden the reproduction band even if the coding bitrate is lowered. As such, the audio signal coding device can inhibit degradation of the audio quality when the bitrate is lowered.

For example, the multiplexer unit may multiplex the coded low-band signal and the coded high-band signal into the coded audio signal, in a manner that the coded low-band signal and the coded high-band signal are separatably allocated to respective regions of the coded audio signal.

According to the above configuration, the audio signal coding device discards the coded high-band signal, thereby reducing the bitrate.

For example, the multiplexer unit may further transmit the coded audio signal to an audio signal decoding device through a transmission path, the audio signal coding device further including a transmission capacity estimation unit configured to estimate a transmission capacity of the transmission path, wherein the layer boundary setting unit may further set the coding bitrate to the first bitrate if the transmission capacity is a first transmission capacity, set the coding bitrate to the second bitrate if the transmission capacity is a second transmission capacity less than the first transmission capacity, and determine the boundary frequency using the set coding bitrate.

According to the above configuration, in environment where the transmission capacity of the transmission path varies from time to time, the audio signal coding device can change the coding bitrate, in response to the variation in transmission capacity.

For example, the transmission path may include a first layer and a second layer having a lower priority than the first layer, and a second layer signal may be discarded if an amount of transmission of the transmission path exceeds a predetermined value, and the multiplexer unit may send the coded audio signal to the transmission path in a manner that the coded low-band signal is allocated to the first layer and the coded high-band signal is allocated to the second layer.

According to the above configuration, if the transmission capacity of the transmission path is scarce, the audio signal coding device discards the coded high-band signal, thereby reducing the bitrate.

For example, the audio signal coding device may further include: an inter-channel correlation detection unit configured to detect a phase difference between channels of an N-channel audio signal and a ratio between levels of the channels to generate inter-channel correlation information indicative of the phase difference and the ratio between the levels, where N is an integer greater than 1; and a downmix unit configured to downmix the N-channel audio signal into an M-channel signal to generate the input audio signal, where M is an integer greater than 0 and smaller than N, wherein the multiplexer unit may multiplex the coded low-band signal, the coded high-band signal, the boundary information, and the inter-channel correlation information to generate the coded audio signal and allocates the inter-channel correlation information to the second layer.

According to the above configuration, if the transmission capacity of the transmission path is scarce, the audio signal coding device discards the inter-channel correlation information, thereby reducing the bitrate.

For example, the layer boundary setting unit may further: set the first frequency band to a first band and the second frequency band to a second band if the coding bitrate is the first bitrate; and set the first frequency band to a third band narrower than the first band and the second frequency band to a fourth band narrower than the second band if the coding bitrate is the second bitrate.

According to the above configuration, the audio signal coding device can reduce the bitrate, if the transmission capacity of the transmission path is scarce.

Moreover, an audio signal decoding device according to an aspect of the present disclosure may be an audio signal decoding device which decodes a coded audio signal which is obtained from coding an input audio signal using a layered coding scheme, the audio signal decoding device including: a splitter unit configured to obtain, from the coded audio signal, a coded low-band signal obtained by coding a low-band signal in a first frequency band lower than a boundary frequency, a coded high-band signal obtained by coding a high-band signal in a second frequency band higher than the boundary frequency, and boundary information indicative of the boundary frequency, the low-band signal and the high-band signal being included in the input audio signal; a low-band signal decoding unit configured to decode the coded low-band signal to generate a decoded low-band signal; a high-band signal decoding unit configured to decode the coded high-band signal, according to the boundary information, to generate a decoded high-band signal; and a combiner unit configured to combine the decoded low-band signal and the decoded high-band signal to generate a decoded audio signal, wherein the combiner unit may generate the decoded audio signal using the decoded low-band signal if the combiner unit fails to obtain the coded high-band signal.

According to the above configuration, the audio signal decoding device can reproduce an audio signal without audio discontinuities, even if the transmission capacity of the transmission path is scarce.

For example, the input audio signal may be obtained by downmixing an N-channel audio signal having N channels into an M-channel signal, where N is an integer greater than 1 and M is an integer greater than 0 and less than N, and the splitter unit may further obtain, from the coded audio signal, inter-channel correlation information indicative of a phase difference between the N channels and a ratio between levels of the N channels, the audio signal decoding device further including an upmix unit configured to upmix the decoded audio signal having M channels to a decoded audio signal having the N channels, using the inter-channel correlation information.

According to the above configuration, the audio signal decoding device can reproduce an audio signal without audio discontinuities, even if the transmission capacity of the transmission path is scarce.

These general and specific aspects may be implemented in a system, a method, an integrated circuit, a computer program, or a computer-readable recording medium such as a CD-ROM, or any combination of systems, methods, integrated circuits, computer programs, or computer-readable recording media.

### Advantageous Effects

The present disclosure can provide the audio signal coding device and the audio signal decoding device which can inhibit degradation of audio quality when the bitrate is lowered.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a block diagram showing a configuration of an audio signal coding device according to a comparative example 1 of the present disclosure.

FIG. 2 is a diagram illustrating a method of switching between coding schemes in the audio signal coding device according to the comparative example 1 of the present disclosure.

FIG. 3 is a block diagram showing a configuration of an audio signal transmission system according to a comparative example 2 of the present disclosure.

FIG. 4 is a diagram showing transitions in code amount and in frequency band of a coded audio signal according to the comparative example 2 of the present disclosure.

FIG. 5 is a block diagram showing a configuration of an audio signal transmission system according to an embodiment 1 of the present disclosure.

FIG. 6 is a block diagram showing a configuration of an audio signal coding device according to the embodiment 1 of the present disclosure.

FIG. 7 is a block diagram showing a configuration of an audio signal decoding device according to the embodiment 1 of the present disclosure.

FIG. 8 is a diagram showing boundary frequencies in response to transmission capacity according to the embodiment 1 of the present disclosure.

FIG. 9 is a diagram showing transitions in code amount and in frequency band of a coded audio signal according to the embodiment 1 of the present disclosure.

FIG. 10 is a flowchart illustrating a coding process performed by the audio signal coding device according to the embodiment 1 of the present disclosure.

FIG. 11 is a flowchart illustrating a decoding process performed by the audio signal decoding device according to the embodiment 1 of the present disclosure.

FIG. 12 is a block diagram showing a configuration of an audio signal coding device according to an embodiment 2 of the present disclosure.

FIG. 13 is a block diagram showing a configuration of an audio signal decoding device according to the embodiment 2 of the present disclosure.

FIG. 14 is a flowchart illustrating a coding process performed by the audio signal coding device according to the embodiment 2 of the present disclosure.

FIG. 15 is a flowchart illustrating a decoding process performed by the audio signal decoding device according to the embodiment 2 of the present disclosure.

### DESCRIPTION OF EMBODIMENTS

First, prior to describing an audio signal coding device according to embodiments of the present disclosure, audio signal coding devices according to comparative examples 1 and 2 of the present disclosure will be set forth.

As described above, the transmission capacity of a transmission path through which the digital signal is transmitted varies from time to time. Thus, when the transmission path is congested, audio-video signals are not transmitted in real time, thereby, in most cases, causing gaps in a reproduced signal. For example, skipping occurs or a screen freezes for a brief moment.

To avoid this, a technique may be employed which estimates the variation in transmission capacity of the transmission path. In this technique, audio-video signals are transmitted at high bitrates when the transmission capacity is large to ensure high image quality and high audio quality, and when the transmission capacity is small, the audio-video signals are transmitted at low bitrates to avoid a reproduced signal skipping and freezing of the image.

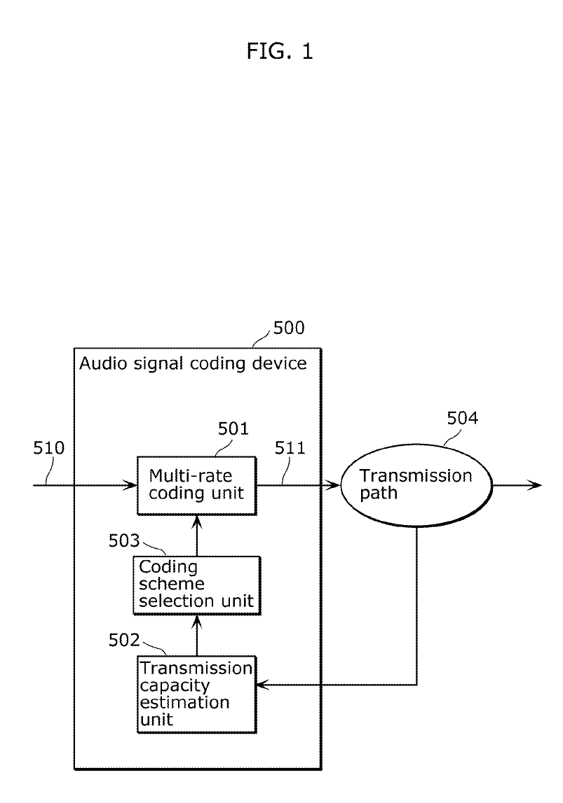

FIG. 1 is a diagram showing an example of the audio signal coding device according to the comparative example 1 of the present disclosure. An audio signal coding device 500 shown in FIG. 1 includes a multi-rate coding unit 501, a transmission capacity estimation unit 502, and a coding scheme selection unit 503.

The multi-rate coding unit 501 codes an input audio signal 510, selectively using one of a plurality of bitrates, to generate a coded audio signal 511. For example, the multi-rate coding unit 501 codes the input audio signal 510 at a bitrate from 24 kbps to 192 kbps. The input audio signal 510 is a stereo signal, for example.

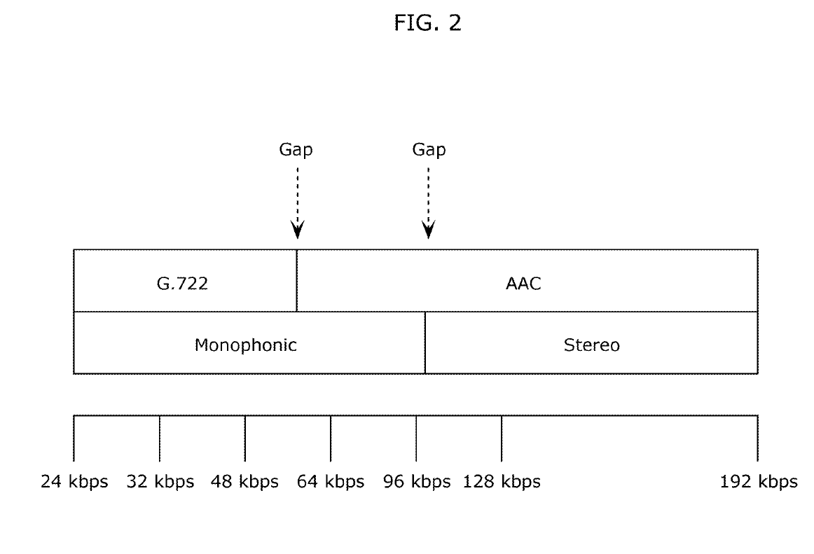

FIG. 2 is a diagram illustrating a method of selecting a coding scheme. As illustrated in FIG. 2, if the bitrate is low the multi-rate coding unit 501 converts the input audio signal 510 into a monophonic signal and then codes it. If the bitrate is high the multi-rate coding unit 501 codes the input audio signal 510 in the form of a stereo signal. Moreover, if the bitrate is low the multi-rate coding unit 501 compression codes the input audio signal 510 by G.722, and if the bitrate is high, compression codes the input audio signal 510 by advance audio coding (AAC). Then, the coded audio signal 511 generated by the compression coding is transmitted through a transmission path 504.

The transmission capacity of the transmission path 504 varies from time to time. The transmission capacity estimation unit 502 estimates the transmission capacity that varies from time to time. It should be noted that specific methods of the processing of estimating the transmission capacity may include a variety of known methods.

The coding scheme selection unit 503 determines the bitrate for audio coding, according to the transmission capacity estimated by the transmission capacity estimation unit 502, and selects a coding scheme that corresponds to the determined bitrate. Specifically, the coding scheme selection unit 503 selects the number of channels (stereo or monophonic) and a compression scheme (AAC or G.722) for a signal to be coded in response to the bitrate. Then, the multi-rate coding unit 501 compression codes the input audio signal 510 using the selected coding scheme.

According to the above configuration, a best-suited coding scheme is selected in response to the transmission capacity that varies from time to time. This allows the audio signal coding device 500 to code the input audio signal 510 at high audio quality when the transmission capacity permits. When the transmission capacity is scarce, the audio signal coding device 500 can transmit an audio signal that has no sound break, although at a degraded audio quality.

In such a method as described above, however, the number of channels of a signal to be coded and the compression scheme changes with the variation in bitrate, which may cause a moment where a reproduced signal does not continue seamlessly. For example, at 192 kbps, the signal is coded by stereo AAC, and at 64 kbps, the signal is coded by monophonic AAC. This causes discontinuities where the reproduction audio switches from stereo to monophonic. Furthermore, at 32 kbps, the signal is coded by monophonic G.722. Thus, discontinuities are caused where the compression scheme switches in the reproduction audio.

The following technique can be used to solve the above problem.

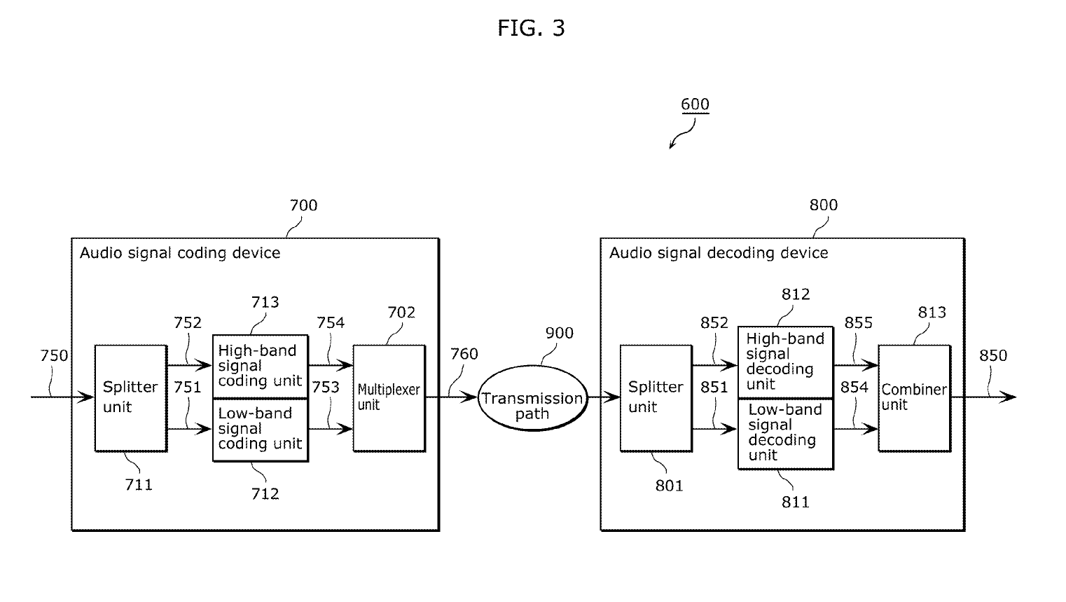

FIG. 3 is a block diagram showing a configuration of an audio signal transmission system according to the comparative example 2 of the present disclosure.

An audio signal transmission system 600 shown in FIG. 3 includes an audio signal coding device 700, an audio signal decoding device 800, and a transmission path 900.

The audio signal coding device 700 codes an input audio signal 750 to generate a coded audio signal 760. The audio signal coding device 700 includes a splitter unit 711, a low-band signal coding unit 712, a high-band signal coding unit 713, and a multiplexer unit 702.

The splitter unit 711 splits the input audio signal 750 into two frequency band signals to generate a low-band signal 751 and a high-band signal 752. The low-band signal coding unit 712 codes the low-band signal 751 to generate a coded low-band signal 753. The high-band signal coding unit 713 codes the high-band signal 752 to generate a coded high-band signal 754. The multiplexer unit 702 multiplexes the coded low-band signal 753 and the coded high-band signal 754 to generate the coded audio signal 760. The coded audio signal 760 is transmitted through the transmission path 900. Here, the coded low-band signal 753 is allocated to a high priority layer of the transmission path 900 and transmitted, and the coded high-band signal 754 is allocated to a low priority layer of the transmission path 900 and transmitted.

The audio signal decoding device 800 receives the coded audio signal 760 transmitted through the transmission path 900. Then, the audio signal decoding device 800 decodes the coded audio signal 760 to generate a decoded audio signal 850. The audio signal decoding device 800 includes a splitter unit 801, a low-band signal decoding unit 811, a high-band signal decoding unit 812, and a combiner unit 813.

The splitter unit 801 splits the coded audio signal 760 into a coded low-band signal 851 and a coded high-band signal 852. The low-band signal decoding unit 811 decodes the coded low-band signal 851 to generate a decoded low-band signal 854. The high-band signal decoding unit 812 decodes the coded high-band signal 852 to generate a decoded high-band signal 855. The combiner unit 813 combines the decoded low-band signal 854 and the decoded high-band signal 855 to generate the decoded audio signal 850 which is a pulse code modulation (PCM) signal.

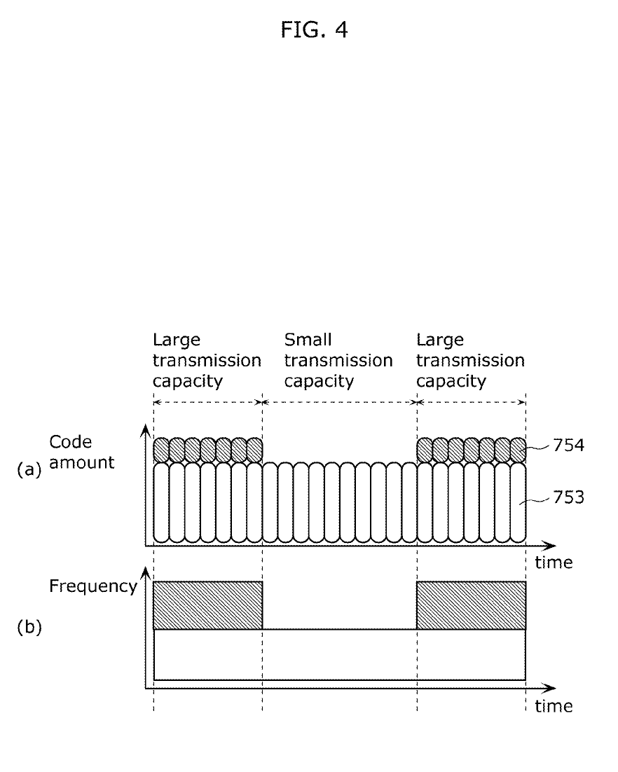

Here, as described above, the coded low-band signal 753 is allocated to the high priority layer of the transmission path 900 and transmitted, and the coded high-band signal 754 is allocated to the low priority layer of the transmission path 900 and transmitted. This is so that the coded high-band signal 754 allocated to the low priority layer of the transmission path 900 is not transmitted if the transmission capacity of the transmission path 900 is scarce. For example, as shown in (a) of FIG. 4, if the transmission capacity permits (large transmission capacity), both the coded low-band signal 753 and the coded high-band signal 754 are transmitted. On the other hand, if the transmission capacity does not permit (small transmission capacity), only the coded low-band signal 753 is transmitted.

If the coded high-band signal 754 (852) is not transmitted, the high-band signal decoding unit 812 outputs, as the decoded high-band signal 855, a zero signal or a signal that mimics a high-band signal.

By so doing, the coded signal is layered, and transmitted in a prioritized manner. Thus, the occurrence of discontinuities in audio with change in the number of channels or change of the coding scheme as indicated in the comparative example 1 can be prevented even if the transmission capacity varies.

As described above, the audio signal transmission system 600 according to the comparative example 2 drops the coded high-band signal 754 when the transmission capacity is scarce due to the congestion of the transmission path 900. However, the size (code amount) of the coded high-band signal 754 is smaller than that of the coded low-band signal 753, and thus the effect of reduction in amount of information to be transmitted, which is obtained by dropping the coded high-band signal 754, is small. In view of this the inventors have found a problem that this processing does not sufficiently contribute to mitigate the congestion of the transmission path 900.

The inventors have also found that the audio quality significantly degrades if the coded high-band signal 754 is dropped because all high-band components (frequency bands above ½ of the reproduction band) are dropped. Here, (a) of FIG. 4 shows transitions in code amount with the variation in transmission capacity. Part (b) of FIG. 4 shows reproduction bands (frequency bands reproduced) with the variation in transmission capacity. As shown in FIG. 4, a wide-band signal is reproduced if the transmission capacity of the transmission path 900 permits, whereas, only a narrow-band signal is reproduced suddenly if the transmission capacity of the transmission path 900 is scarce.

Hereinafter, embodiments according to the present disclosure will be described in details, with reference to the accompanying drawings. It should be noted that embodiments described below are generic and specific illustration of the present disclosure. Values, shapes, materials, components, arrangement or connection between the components, steps, and the order of the steps are merely illustrative and not intended to limit the present disclosure. Moreover, among components of the embodiments below, components not set forth in the independent claims indicating the top level concept of the present disclosure will be described as optional components.

### EMBODIMENT 1

Hereinafter, an audio signal coding device and audio signal decoding device according to an embodiment 1 of the present disclosure will be described, with reference to the accompanying drawings.

The audio signal coding device according to the present embodiment changes a boundary frequency which is used in signal splitting, in response to a transmission capacity of a transmission path. This allows the audio signal coding device to appropriately correspond to the variation in transmission capacity of the transmission path.

First, a configuration of an audio signal transmission system 100 according to the present embodiment will be described.

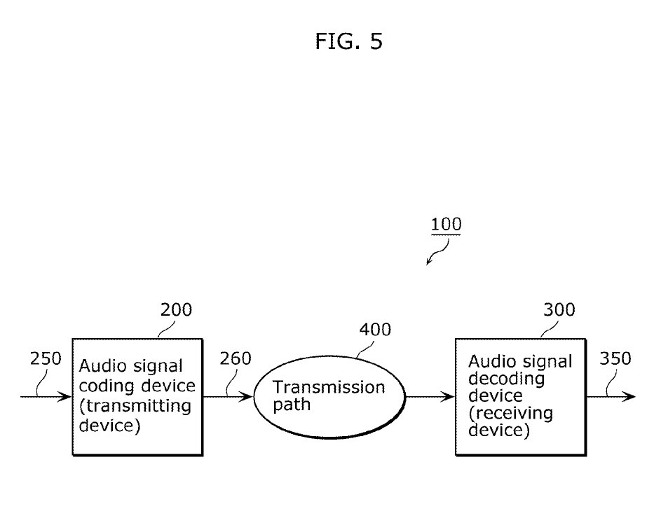

FIG. 5 is a block diagram showing a configuration of the audio signal transmission system 100 according to the present embodiment. The audio signal transmission system 100 shown in FIG. 1 includes an audio signal coding device 200 (a transmitting device), an audio signal decoding device 300 (a receiving device), and a transmission path 400.

The audio signal coding device 200 codes an input audio signal 250 to generate a coded audio signal 260. Then, the audio signal coding device 200 transmits the coded audio signal 260 to the audio signal decoding device 300 through the transmission path 400.

The audio signal decoding device 300 receives the coded audio signal 260, and decodes the coded audio signal 260 to generate a decoded audio signal 350.

In the following, a configuration of the audio signal coding device 200 will be described.

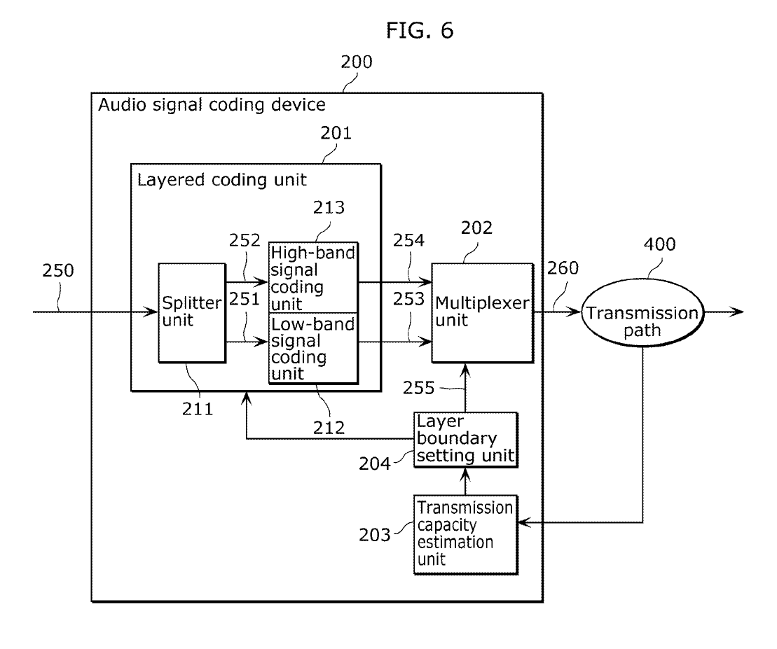

FIG. 6 is a block diagram showing a configuration of the audio signal coding device 200 according to the present embodiment. The audio signal coding device 200 shown in FIG. 6 includes a layered coding unit 201, a multiplexer unit 202, a transmission capacity estimation unit 203, and a layer boundary setting unit 204.

The layered coding unit 201 splits the input audio signal 250 into two frequency band signals and codes the signals in a layered manner. Specifically, the layered coding unit 201 codes a low-band signal 251, which is included in the input audio signal 250 and in a first frequency band lower than a boundary frequency, to generate a coded low-band signal 253. The layered coding unit 201 also codes a high-band signal 252, which is included in the input audio signal 250 and in a second frequency band higher than the boundary frequency, to generate a coded high-band signal 254. The layered coding unit 201 includes a splitter unit 211, a low-band signal coding unit 212, and a high-band signal coding unit 213. The splitter unit 211 splits the input audio signal 250 into at least two frequency band signals. For example, the splitter unit 211 splits the input audio signal 250 into the low-band signal 251 and the high-band signal 252. The low-band signal coding unit 212 codes the low-band signal 251 to generate the coded low-band signal 253. The high-band signal coding unit 213 codes the high-band signal 252 to generate the coded high-band signal 254.

The multiplexer unit 202 multiplexes the coded low-band signal 253, the coded high-band signal 254, and boundary information 255 described below to generate the coded audio signal 260. The multiplexer unit 202 multiplexes the coded low-band signal 253 and the coded high-band signal 254 in a manner that the coded low-band signal 253 and the coded high-band signal 254 are separatably allocated to respective regions of the coded audio signal 260.

The coded audio signal 260 generated by the multiplexer unit 202 is transmitted through the transmission path 400. Here, the multiplexer unit 202 allocates the coded low-band signal 253 to a high priority layer (a first layer) of the transmission path 400 and the coded high-band signal 254 to a low priority layer (a second layer) of the transmission path 400 to send the coded audio signal 260 to the transmission path 400.

Here, the transmission path 400 has the first layer and the second layer having a lower priority than the first layer, and discards a signal on the second layer if an amount of transmission of the transmission path 400 exceeds a predetermined value.

The transmission capacity estimation unit 203 estimates the transmission capacity of the transmission path 400.

In response to the transmission capacity estimated by the transmission capacity estimation unit 203, the layer boundary setting unit 204 determines a frequency band signal to be handled as the low-band signal 251 and a frequency band signal to be handled as the high-band signal 252.

Specifically, the transmission capacity estimation unit 203 determines the above-mentioned boundary frequency. More specifically, the layer boundary setting unit 204 determines a coding bitrate to be used in coding signals by the layered coding unit 201. If the coding bitrate is a first bitrate, the layer boundary setting unit 204 sets the boundary frequency to a first frequency, and, if the coding bitrate is a second bitrate lower than the first bitrate, sets the boundary frequency to a second frequency lower than the first frequency. In other words, the lower the coding bitrate is the lower the layer boundary setting unit 204 sets the boundary frequency.

The layer boundary setting unit 204 may determine the above-mentioned coding bitrate, in response to a transmission capacity of the transmission path 400. Specifically, if the transmission capacity is a first transmission capacity, the layer boundary setting unit 204 sets the coding bitrate to the first bitrate, and, if the transmission capacity is a second transmission capacity less than the first transmission capacity, sets the coding bitrate to the second bitrate lower than the first bitrate. In other words, the less the transmission capacity is the lower the layer boundary setting unit 204 sets the coding bit. The layer boundary setting unit 204 also sets the boundary frequency, using the determined coding bitrate.

In other words, the layer boundary setting unit 204 determines the boundary frequency, in response to a transmission capacity of the transmission path 400. In other words, if the transmission capacity is the first transmission capacity the layer boundary setting unit 204 sets the boundary frequency to the first frequency, and, if the transmission capacity is the second transmission capacity less than the first transmission capacity, sets the boundary frequency to the second frequency lower than the first frequency.

The layer boundary setting unit 204 also generates the boundary information 255 indicating the boundary frequency, and outputs the boundary information 255 to the multiplexer unit 202.

Moreover, the layer boundary setting unit 204 may change a frequency band of a signal to be coded, in response to the coding bitrate or the transmission capacity. Specifically, if the coding bitrate is the first bitrate, the layer boundary setting unit 204 sets the first frequency band of the low-band signal 251 to a first band and sets the second frequency band of the high-band signal 252 to a second band . If the coding bitrate is the second bitrate lower than the first bitrate, the layer boundary setting unit 204 sets the first frequency band of the low-band signal 251 to a third band narrower than the first band, and sets the second frequency band of the high-band signal 252 to a fourth band narrower than the second band. In other words, the lower the coding bitrate is (the less the transmission capacity is) the narrower the layer boundary setting unit 204 sets the frequency bands of the low-band signal 251 and the high-band signal 252 which are to be coded. It should be noted that the layer boundary setting unit 204 may set, narrow, the frequency band of one of the low-band signal 251 and the high-band signal 252 to be coded, in response to the coding bitrate or the transmission capacity.

Next, a configuration of the audio signal decoding device 300 will be described.

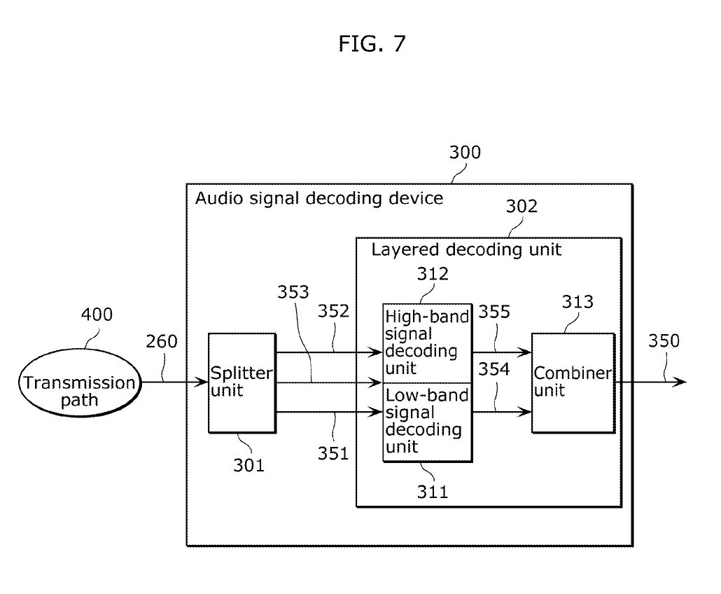

FIG. 7 is a block diagram showing a configuration of the audio signal decoding device 300 according to the present embodiment. The audio signal decoding device 300 shown in FIG. 7 includes a splitter unit 301 and a layered decoding unit 302.

The splitter unit 301 obtains a coded low-band signal 351, a coded high-band signal 352, and boundary information 353 from the coded audio signal 260 received through the transmission path 400. Here, the coded low-band signal 351, the coded high-band signal 352, and the boundary information 353 correspond to the coded low-band signal 253, the coded high-band signal 254, and the boundary information 255, respectively, which are generated by the audio signal coding device 200. In other words, the coded low-band signal 351 is a signal obtained by coding the low-band signal 251 which is included in the input audio signal 250 and in the first frequency band lower than the boundary frequency. The coded high-band signal 352 is a signal obtained by coding the high-band signal 252 which is included in the input audio signal 250 and in the second frequency band higher than the boundary frequency. The boundary information 353 is information indicative of the boundary frequency.

The layered decoding unit 302 decodes the coded low-band signal 351 and the coded high-band signal 352 using the boundary information 353 to generate the decoded audio signal 350. The layered decoding unit 302 includes a low-band signal decoding unit 311, a high-band signal decoding unit 312, and a combiner unit 313.

The low-band signal decoding unit 311 decodes the coded low-band signal 351 using the boundary information 353 to generate a decoded low-band signal 354. The high-band signal decoding unit 312 decodes the coded high-band signal 352 using the boundary information 353 to generate a decoded high-band signal 355. It should be noted that the boundary information 353 may be used by either one of the low-band signal decoding unit 311 and the high-band signal decoding unit 312.

The combiner unit 313 combines the decoded low-band signal 354 and the decoded high-band signal 355 to generate the decoded audio signal 350 which is a PCM signal. If failed to obtain the coded high-band signal 352, the combiner unit 313 generates the decoded audio signal 350, using the decoded low-band signal 354.

Operation of the audio signal coding device 200 and the audio signal decoding device 300 configured as described above will be described below.

First, operation of the audio signal coding device 200 will be described.

The splitter unit 211 splits the input audio signal 250 into a plurality of frequency band signals. For example, the splitter unit 211 splits the input audio signal 250 into 64 frequency-band split signals.

Next, the low-band signal coding unit 212 codes a plurality of low-band split signals among the plurality of split signals generated by the splitter unit 211 to generate the coded low-band signal 253. Specifically, the low-band signal coding unit 212 codes a plurality of split signals in low frequency bands (corresponding to the low-band signal 251 mentioned above) among the 64 split signals. It should be noted that which frequency band signal the low-band signal coding unit 212 is to code is determined by the layer boundary setting unit 204.

Meanwhile, the high-band signal coding unit 213 codes a plurality of high-band split signals among the plurality of split signals generated by the splitter unit 211 to generate the coded high-band signal 254. Specifically, the high-band signal coding unit 213 codes a plurality of split signals in high frequency bands (corresponding to the high-band signal 252 mentioned above) among the 64 split signals. It should be noted that which frequency band signal the high-band signal coding unit 213 is to code is determined by the layer boundary setting unit 204. Details of the operation will be described below.

The multiplexer unit 202 multiplexes the coded low-band signal 253, the coded high-band signal 254, and the boundary information 255 to generate the coded audio signal 260. The coded audio signal 260 is transmitted through the transmission path 400. Here, as described above, the coded low-band signal 253 is allocated to the high priority layer of the transmission path 400 and transmitted, and the coded high-band signal 254 is allocated to the low priority layer of the transmission path 400 and transmitted. This is so that the coded high-band signal 254 allocated to the low priority layer is not transmitted if the transmission capacity of the transmission path 400 is scarce.

Here, since the transmission capacity of the transmission path 400 is a variable one, the coded audio signal 260 is rapidly transmitted in a time period where the transmission capacity permits, even if the bitrate is high. Therefore, audio discontinuities do not occur, for example. There is thus no problem in that the bitrate is high. On the other hand, in a time period where the transmission capacity is scarce, the bitrate of the coded audio signal 260 need be low. Thus, the transmission capacity estimation unit 203 estimates the transmission capacity of the transmission path 400 that varies from time to time as such. The method of estimating the transmission capacity may be any that is conventionally known.

In response to the transmission capacity estimated by the transmission capacity estimation unit 203, the layer boundary setting unit 204 determines a boundary frequency which is a boundary between the frequency band of the low-band signal 251 to be coded by the low-band signal coding unit 212 and the frequency band of the high-band signal 252 to be coded by the high-band signal coding unit 213.

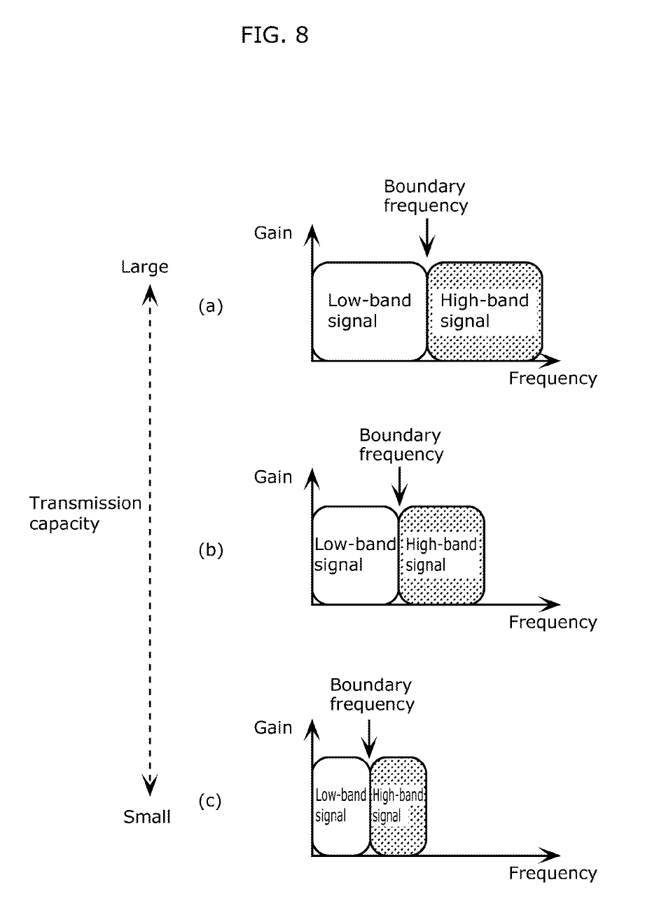

FIG. 8 is a diagram illustrating an outline of a process of determining the boundary frequency.

For example, if the transmission capacity is large, as shown in (a) of FIG. 8, the layer boundary setting unit 204 sets the boundary frequency to a frequency at ½ of the reproduction band of the input audio signal 250. If the transmission capacity is small, as shown in (b) of FIG. 8, the layer boundary setting unit 204 sets the boundary frequency to a frequency at ⅓ of the reproduction band of the input audio signal 250, for example. If the transmission capacity is even smaller, as shown in (c) of FIG. 8, the layer boundary setting unit 204 sets the boundary frequency to a frequency at ¼ of the reproduction band of the input audio signal 250, for example. It should be noted that values, ½, ⅓, and ¼ mentioned here are merely illustrative and may be appropriately determined in accordance with the magnitude of the transmission capacity.

In the following, the operation of the low-band signal coding unit 212 and the high-band signal coding unit 213 will be described in detail. First, a specific example operation of the low-band signal coding unit 212 will be described.

The low-band signal coding unit 212 codes lowest 32 split signals among the 64 split signals generated by the splitter unit 211 if the boundary frequency is the frequency at ½ of the reproduction band. Although any method may be employed for coding signals, for example, the low-band signal coding unit 212 performs band synthesis on the 32 split signals to generate time-domain signals, and codes the generated time-domain signals by MPEG standards AAC.

If the boundary frequency is the frequency at ⅓ of the reproduction band, the low-band signal coding unit 212 codes lowest 21 split signals among the 64 split signals. Although any method may be employed for coding signals, for example, the low-band signal coding unit 212 performs the band synthesis on the lowest 32 split signals to generate time-domain signals as with the case where the boundary frequency is the frequency at ½ of the reproduction band. Then, the low-band signal coding unit 212 codes the generated time-domain signals by MPEG standards AAC. Here, since the 32 split signals has undergone the band synthesis, the frequency band of the generated time-domain signals is ½ of the frequency band of the original input audio signal 250. Thus, the low-band signal coding unit 212 codes, among the generated time-domain signals, time-domain signals in ⅔ of the frequency band of the generated time-domain signals by AAC. The functionality of AAC is used which codes an arbitrary frequency band of the input signal.

Furthermore, if the boundary frequency is the frequency at ¼ of the reproduction band, the low-band signal coding unit 212 codes lowest 16 split signals among the 64 split signals. Although any method may be employed for coding signals, for example, the low-band signal coding unit 212 performs the band synthesis on the lowest 32 split signals to generate time-domain signals as with the case where the boundary frequency is the frequency at ½ of the reproduction band. Then, the low-band signal coding unit 212 codes the generated time-domain signals by MPEG standards AAC. Here, since the 32 split signals has undergone the band synthesis, the frequency band of the generated time-domain signals is ½ of the frequency band of the original input audio signal 250. Thus, the low-band signal coding unit 212 codes, among the generated time-domain signals, time-domain signals in ½ of the frequency band of the generated time-domain signals by AAC. As described above, the functionality of AAC is used which codes an arbitrary frequency band of the input signal.

Next, a specific example operation of the high-band signal coding unit 213 will be described. If the boundary frequency is the frequency at ½ of the reproduction band, the high-band signal coding unit 213 codes highest 32 split signals among the 64 split signals. Although any method may be employed for coding signals, for example, the high-band signal coding unit 213 employs spectral band replication (SBR) technology. SBR is standardized as a high-efficiency advanced audio coding (HEAAC) scheme, which replicates and shapes a low-band frequency signal into a high-band frequency signal, thereby coding a wideband signal at a small bitrate. In the present embodiment, the high-band signal coding unit 213 uses the aforementioned low-band signal 251, which has been coded by AAC, as a low-band frequency signal to replicate and shape the low-band frequency signal into a high-band frequency signal, thereby coding the high-band signal 252. In other words, the high-band signal coding unit 213 codes information as to which band signal in the low-band signal 251 is to be replicated and how it is shaped, thereby coding the high-band signal 252 using small code amount.

Moreover, if the boundary frequency is the frequency at ⅓ of the reproduction band, the high-band signal coding unit 213 codes, among the 64 split signals, signals above the band of the 21st lowest band signal. In other words, the high-band signal coding unit 213 codes the highest 43 band signals among the 64 split signals. Although any method may be employed for coding signals, again, SBR may be employed. In the present embodiment, using the aforementioned low-band signal 251 (21 band signals) coded by AAC as a low-band signal, the high-band signal coding unit 213 replicates and shapes the low-band signal, thereby coding the high-band signal 252. In this case, 43 high-band split signals need not necessarily be coded, and signals covering about ⅔ of the frequency band of the input audio signal 250 may be coded. Moreover, if the boundary frequency is the frequency at ¼ of the reproduction band, the high-band signal coding unit 213 codes, among the 64 split signals, signals above the band of the 16th lowest band signal. In other words, the high-band signal coding unit 213 codes the highest 48 band signals among the 64 split signals. Although any method may be employed for coding signals, again, SBR may be employed. In the present embodiment, using the aforementioned low-band signal 251 (16 band signals) coded by AAC as a low-band signal, the high-band signal coding unit 213 replicates and shapes the low-band signal, thereby coding the high-band signal 252. In this case, 48 high-band split signals need not necessarily be coded, and signals covering about ½ of the frequency band of the input audio signal 250 may be coded.

In the present embodiment, the boundary information 255 generated by the layer boundary setting unit 204 is information which indicates which band signal is to be coded by AAC and which band signal is to be coded by SBR. The boundary information 255 is used on the decoding side and thus the multiplexer unit 202 multiplexes the boundary information 255 to generate the coded audio signal 260.

Then, the coded audio signal 260 is transmitted through the transmission path 400.

Next, operation of the audio signal decoding device 300 will be described.

The splitter unit 301 splits the coded audio signal 260 transmitted through the transmission path 400 into the coded low-band signal 351 obtained by coding the low-band signal, the coded high-band signal 352 obtained by coding the high-band signal, and the boundary information 353.

The low-band signal decoding unit 311 decodes the coded low-band signal 351 to generate the decoded low-band signal 354. The high-band signal decoding unit 312 decodes the coded high-band signal 352 to generate the decoded high-band signal 355. Here, the low-band signal decoding unit 311 and the high-band signal decoding unit 312 obtain information as to a boundary between the low band and the high band from the boundary information 353 indicating a layer boundary.

The combiner unit 313 combines the decoded low-band signal 354 and the decoded high-band signal 355 to generate the decoded audio signal 350 which is a PCM signal.

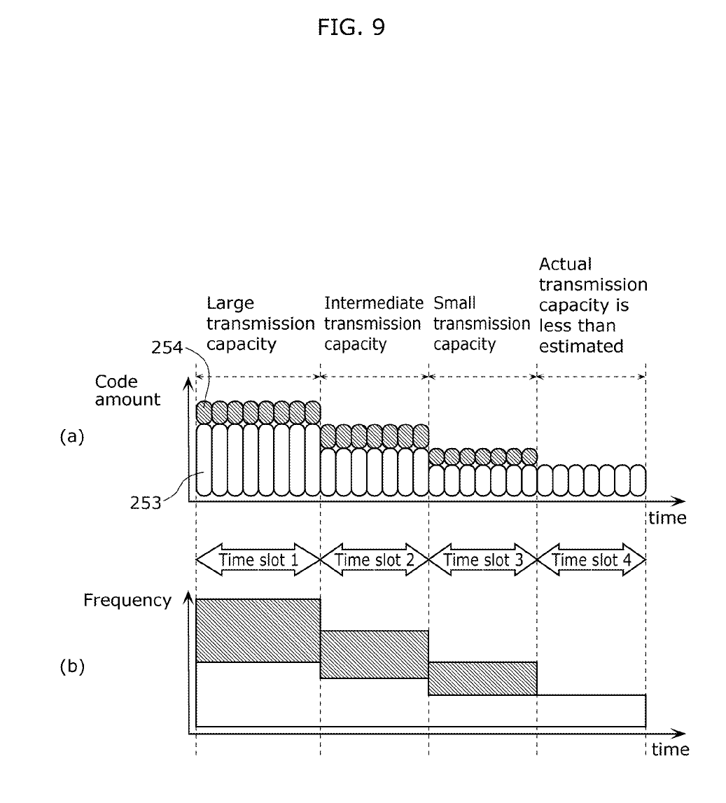

FIG. 9 is a diagram showing examples of transitions in code amount for the coded audio signal 260 generated by the series of processing as described above ((a) of FIG. 9), and transitions in frequency band of the decoded audio signal 350 reproduced on the decoding side ((b) of FIG. 9).

In a time slot 1, the transmission capacity of the transmission path 400 is adequate (large transmission capacity), and the coded low-band signal 253 and the coded high-band signal 254 are allocated sufficient code amounts. As previously mentioned, the coded low-band signal 253 has been coded by AAC and the coded high-band signal 254 has been coded by SBR. Thus, the code amount for the coded low-band signal 253 is large while the code amount for the coded high-band signal 254 is small. As shown in (b) of FIG. 9, the audio signal decoding device 300 can reproduce a full-band signal.

In a time slot 2, the transmission capacity of the transmission path 400 is becoming scarce (intermediate transmission capacity). In this case, the audio signal coding device 200 somewhat lowers the layer boundary (the boundary frequency) to reduce the code amount for the coded low-band signal 253. Since the code amount for the coded low-band signal 253 is originally large, slightly lowering the layer boundary allows large reduction in code amount. On the other hand, the code amount for the coded high-band signal 254 is originally small. Thus, the coded high-band signal 254 is allocated sufficient code amount in the time slot 2 as well. As a result, as shown in (b) of FIG. 9, the reproduction band of the signal reproduced by the audio signal decoding device 300 is not greatly compromised. For example, comparison is made with the example illustrated in FIG. 4. In the period where the transmission capacity is small in FIG. 4, the reproduction band is about half of a normal state (large transmission capacity). On the other hand, in the time slot 2 shown in FIG. 9, the reproduction band is half or more of the normal state while the total code amount is similar to that illustrated in FIG. 4. In other words, a decrease in reproduction band when the bitrate is lowered is reduced.

In a time slot 3, the transmission capacity of the transmission path 400 is becoming further scarce (small transmission capacity). In this case, the audio signal coding device 200 lowers the layer boundary a little further to reduce the code amount for the coded low-band signal 253. The code amount for the coded low-band signal 253 is originally large, and thus further lowering the layer boundary reduces large code amount. On the other hand, the code amount for the coded high-band signal 254 slightly reduces in the time slot 3 as well, even though the code amount for the coded high-band signal 254 is originally small. This is because the band of the low-band signal referred to by SBR is narrowed and thus there is little point in allocating large code amount to the coded high-band signal 254. As a result, as shown in (b) of FIG. 9, the reproduction band of the signal which is reproduced by the audio signal decoding device 300 is not significantly compromised. For example, compared to the example shown in FIG. 4, although the reproduction band in the time slot 3 shown in FIG. 9 is similar to the time slot where the transmission capacity is small shown in FIG. 4, the total code amount is less than that shown in FIG. 4. In other words, a decrease in reproduction band when the bitrate is lowered is reduced.

In a time slot 4, the transmission capacity of the transmission path 400 is further scarce. As a result, the actual transmission capacity is less than the transmission capacity estimated by the transmission capacity estimation unit 203.

Here, as described above, the transmission path 400 has functionality of discarding a signal on a low priority layer when the amount of transmission exceeds a predetermined value. Therefore, in this case, the coded high-band signal 254 which is allocated to the low priority layer of the transmission path 400 and transmitted is discarded, in which case, the high-band signal decoding unit 312 included in the audio signal decoding device 300 generates, as the decoded high-band signal 355, a zero signal or a signal which mimics a high-band signal. As a result, the reproduction band of a signal which is reproduced by the audio signal decoding device 300 is compromised as shown in (b) FIG. 9, but audio discontinuities or the like which are due to scarceness of the transmission capacity do not occur.

In the following, the process flows by the audio signal coding device 200 and the audio signal decoding device 300 will be described.

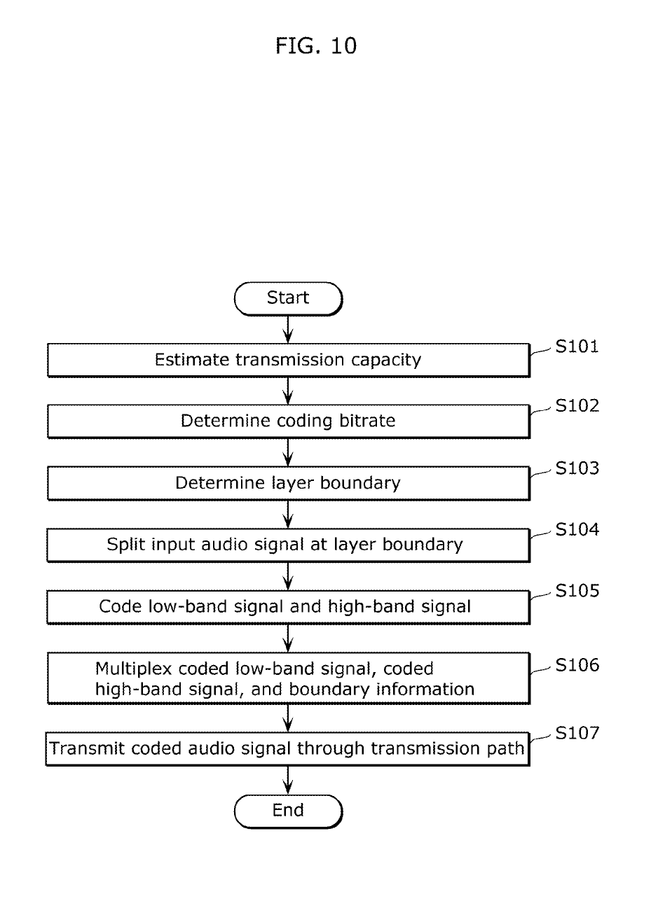

FIG. 10 is a flowchart illustrating the audio signal coding process performed by the audio signal coding device 200.

First, the transmission capacity estimation unit 203 estimates transmission capacity of the transmission path 400 (S101).

Next, the layer boundary setting unit 204 determines a coding bitrate to be used by the layered coding unit 201 for signal coding, according to the estimated transmission capacity (S102). The layer boundary setting unit 204 also determines the layer boundary (the boundary frequency), based on the determined coding bitrate (S103). Moreover, the layer boundary setting unit 204 generates the boundary information 255 which indicates the determined layer boundary.

Next, the splitter unit 211 splits the input audio signal 250 at the layer boundary determined in step S103 to generate the low-band signal 251 and the high-band signal 252 (S104).

Next, the low-band signal coding unit 212 codes the low-band signal 251 to generate the coded low-band signal 253. The high-band signal coding unit 213 codes the high-band signal 252 to generate the coded high-band signal 254 (S105).

Next, the multiplexer unit 202 multiplexes the coded low-band signal 253, the coded high-band signal 254, and the boundary information 255 to generate the coded audio signal 260 (S106). Last, the multiplexer unit 202 transmits the coded audio signal 260 generated in step 106 through the transmission path 400 (S107).

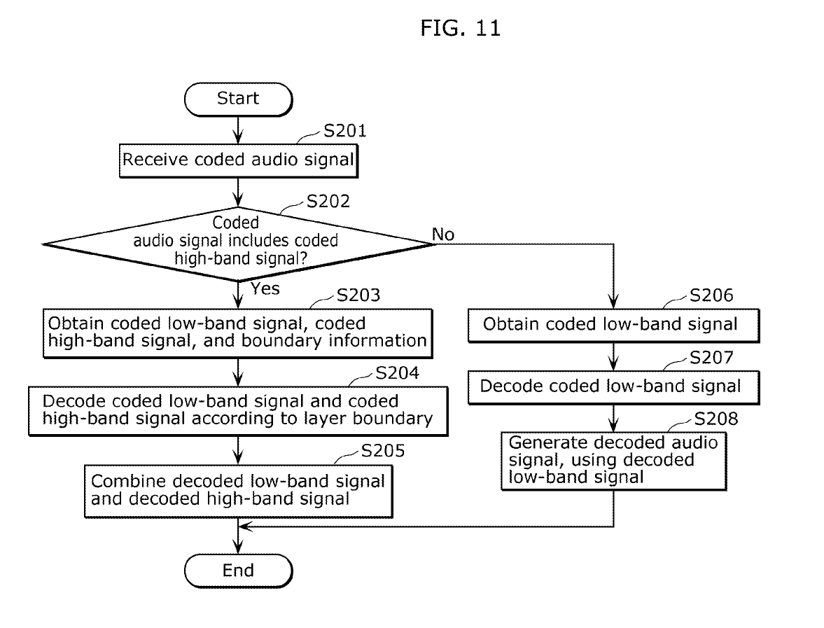

FIG. 11 is a flowchart illustrating the audio signal decoding process performed by the audio signal decoding device 300.

First, the splitter unit 301 receives the coded audio signal 260 transmitted through the transmission path 400 (S201).

Next, the splitter unit 301 determines whether the coded audio signal 260 includes the coded high-band signal 352 (S202).

If the coded audio signal 260 includes the coded high-band signal 352 (Yes in S202), the splitter unit 301 obtains the coded low-band signal 351, the coded high-band signal 352, and the boundary information 353 that are included in the coded audio signal 260 (S203).

Next, the layered decoding unit 302 decodes the coded low-band signal 351 and the coded high-band signal 352 according to the layer boundary (the boundary frequency) indicated by the boundary information 353, to generate the decoded low-band signal 354 and the decoded high-band signal 355 (S204).

Next, the combiner unit 313 combines the decoded low-band signal 354 and the decoded high-band signal 355 to generate the decoded audio signal 350 (S205).

In contrast, if the coded audio signal 260 does not include the coded high-band signal 352 (No in S202), the splitter unit 301 obtains the coded low-band signal 351 included in the coded audio signal 260 (S206).

Next, the layered decoding unit 302 decodes the coded low-band signal 351 to generate the decoded low-band signal 354 (S207).

Next, the combiner unit 313 generates the decoded audio signal 350, using the decoded low-band signal 354 (S208).

As described above, the audio signal coding device 200 according to the present embodiment changes the boundary frequency used in signal splitting, in response to a transmission capacity of the transmission path 400. Specifically, if the transmission capacity is large, the audio signal coding device 200 sets the boundary frequency high, and if the transmission capacity is small, sets the boundary frequency low. This allows the audio signal coding device 200 to appropriately correspond to the variation in transmission capacity of the transmission path 400.

As such, the audio signal coding device 200 can switch the coding bitrate in response to the transmission capacity even if the layered coding scheme in which the frequency band is split and coded is employed in environment where the transmission capacity of the transmission path 400 varies from time to time. Moreover, the audio signal coding device 200 can inhibit the decrease in reproduction band when the coding bitrate is lowered. Furthermore, even if the transmission capacity of the transmission path 400 is further scarce, the audio signal coding device 200 discards a high-band signal, thereby reducing the bitrate.

### EMBODIMENT 2

In the embodiment 1 described above, the number of channels of the input audio signal 250 is not particularly limited. The input audio signal 250 may be a 1-channel signal, 2-channel signal, 5.1-channel signal, 7.1-channel signal, or be of any other number of channels. The above-described processing may be implemented in response to each channel signal.

Meanwhile, to further correspond to the variation in transmission capacity of the transmission path, that is, to ensure no audio discontinuities occur even if the transmission capacity is further scarce, a technique may be applied which upmixes a downmixed signal using correlation between channels.

The present embodiment will describe the case where such downmixing and upmixing are performed.

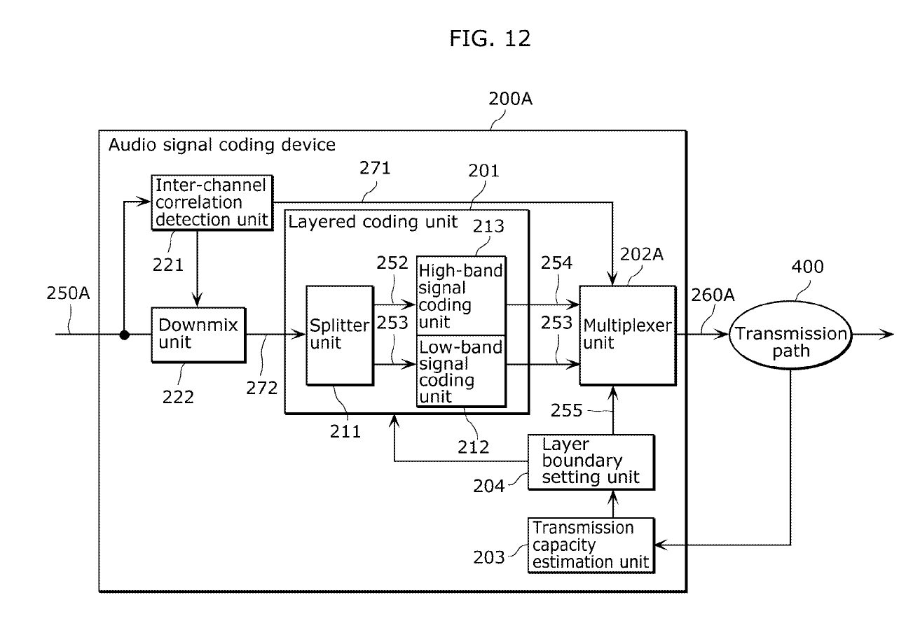

FIG. 12 is a block diagram of an audio signal coding device 200A according to the present embodiment. It should be noted that the same reference signs as those in FIG. 6 will be used in FIG. 12 to refer to the same components, and a difference of the present embodiment from the embodiment 1 will be mainly described below.

The audio signal coding device 200A shown in FIG. 12 includes an inter-channel correlation detection unit 221 and a downmix unit 222, in addition to the configuration of the audio signal coding device 200 shown in FIG. 6. The audio signal coding device 200A includes a multiplexer unit 202A which is different in functionality from the multiplexer unit 202.

The audio signal coding device 200A codes an input audio signal 250A to generate a coded audio signal 260A. The input audio signal 250A is an N-channel audio signal (where N is an integer greater than 1), for example, a 7.1-channel signal or a 5.1-channel signal.

The inter-channel correlation detection unit 221 detects a phase difference between channels of the N-channel input audio signal 250A and a ratio between levels of the channels, and generates inter-channel correlation information 271 indicative of the phase difference and the ratio between the levels.

Using the inter-channel correlation information 271, the downmix unit 222 downmixes the N-channel input audio signal 250A into an M-channel signal (M<N) to generate a downmix signal 272. For example, the downmix unit 222 downmixes a 7.1-channel signal or a 5.1-channel signal into a 2-channel signal or a 1-channel signal. The downmix unit 222 may downmix a 2-channel signal into a 1-channel signal.

Examples of the inter-channel correlation information 271 include a phase difference information or gain ratio information between the channels, i.e., information standardized by MPEG standards MPEG surround scheme.

It should be noted that the layered coding unit 201 performs the same operation on the downmix signal 272 as performed on the above-described input audio signal 250.

The multiplexer unit 202A multiplexes the inter-channel correlation information 271, in addition to the coded low-band signal 253, the coded high-band signal 254, and the boundary information 255, to generate the coded audio signal 260A.

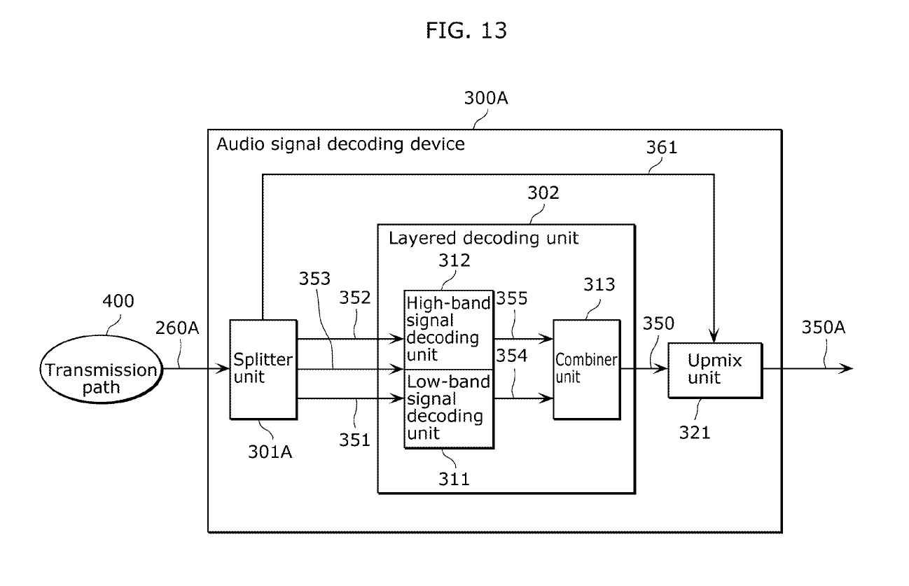

FIG. 13 is a block diagram of the audio signal decoding device 300A which decodes the coded audio signal 260A. It should be noted that the same reference signs as those in FIG. 7 will be used in FIG. 13 to refer to the same components, and a difference of the present embodiment from the embodiment 1 will be mainly described below.

The audio signal decoding device 300A shown in FIG. 13 includes an upmix unit 321, in addition to the configuration of the audio signal decoding device 300 shown in FIG. 7. The audio signal decoding device 300A includes a splitter unit 301A which is different in functionality from the splitter unit 301.

The audio signal decoding device 300A decodes the coded audio signal 260A to generate the decoded audio signal 350A.

In addition to the functionality of the splitter unit 301 described above, the splitter unit 301A splits inter-channel correlation information 361 from the coded audio signal 260A and sends it to the upmix unit 321. The inter-channel correlation information 361 corresponds to the inter-channel correlation information 271 generated by the audio signal coding device 200A.

The upmix unit 321 upmixes the M-channel decoded audio signal 350 into the N-channel decoded audio signal 350A (N>M), using, for example, the phase difference information between channels or the gain ratio information between the channels indicated by the inter-channel correlation information 271. This method of upmixing is standardized by MPEG standards MPEG surround scheme, for example.

Here, the multiplexer unit 202A allocates the inter-channel correlation information 271 to a low priority layer of the transmission path 400, as with the coded high-band signal 254. This may result in further reduction in bitrate by dropping the inter-channel correlation information 271 when the transmission capacity of the transmission path 400 is scarce. This no longer allows upmixing of the number of channels but avoids occurrence of audio discontinuities.

In the following, the process flows by the audio signal coding device 200A and the audio signal decoding device 300A will be described.

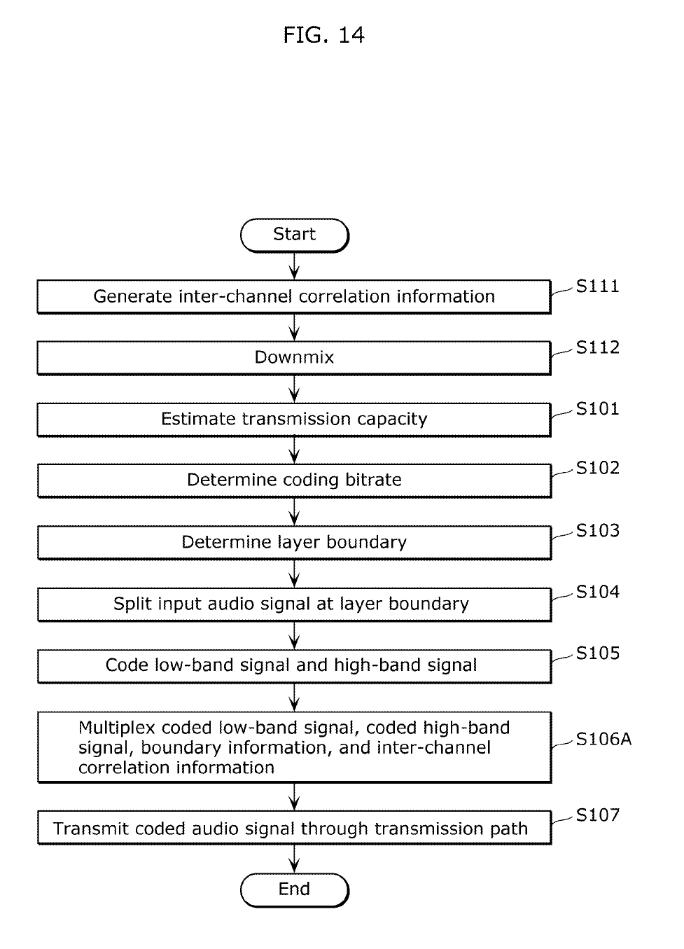

FIG. 14 is a flowchart illustrating the audio signal coding process performed by the audio signal coding device 200A. It should be noted that the same reference signs as those in FIG. 10 will be used in FIG. 14 to refer to the same components, and a difference of the present embodiment from the embodiment 1 will be mainly described below.

The processing illustrated in FIG. 14 further includes steps S111 and S112, in addition to the steps included in the processing illustrated in FIG. 10. The processing illustrated in FIG. 14 includes step S106A in place of step S106.

First, the inter-channel correlation detection unit 221 detects a phase difference between channels of the N-channel input audio signal 250A and a ratio of levels between the channels, and generates the inter-channel correlation information 271 indicative of the phase difference and the ratio of the levels (S111).

Next, using the inter-channel correlation information 271 the downmix unit 222 downmixes the N-channel input audio signal 250A into an M-channel signal (M<N) to generate the downmix signal 272 (S112). It should be noted that steps S101 to S105 are the same as those illustrated in FIG. 10.

Next, the multiplexer unit 202A multiplexes the coded low-band signal 253, the coded high-band signal 254, the boundary information 255, and the inter-channel correlation information 271 to generate the coded audio signal 260A (S106A).

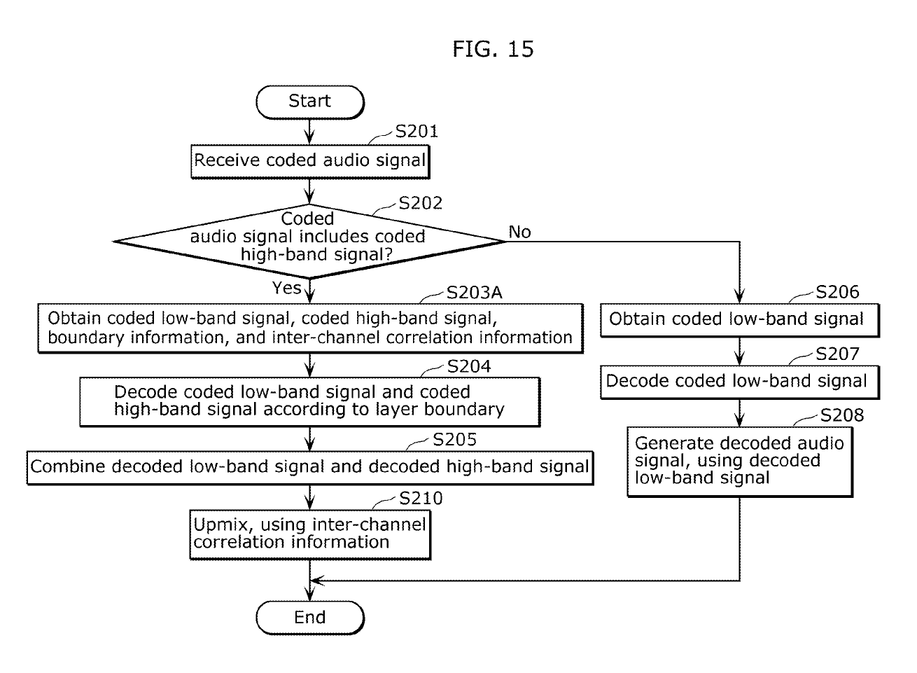

FIG. 15 is a flowchart illustrating the audio signal decoding process performed by the audio signal decoding device 300A. It should be noted that the same reference signs as those in FIG. 11 will be used in FIG. 15 to refer to the same processes, and a difference of the present embodiment from the embodiment 1 will be mainly described below.

The processing illustrated in FIG. 15 further includes step S210, in addition to the steps included the processing illustrated in FIG. 11. The processing illustrated in FIG. 15 includes step S203A in place of step S203.

If the coded audio signal 260A includes the coded high-band signal 352 (Yes in S202), the splitter unit 301 obtains the coded low-band signal 351, the coded high-band signal 352, the boundary information 353, and the inter-channel correlation information 361 which are included in the coded audio signal 260 (S203A). It should be noted that steps S204 and S205 are the same as those illustrated in FIG. 11.

Next, the upmix unit 321 upmixes the M-channel decoded audio signal 350 using the inter-channel correlation information 361 to generate the N-channel decoded audio signal 350A (S210).

The audio signal coding device and audio signal decoding device according to the embodiments of the present disclosure have been described. The present disclosure, however, is not limited to the embodiments.

Moreover, the processing components included in the audio signal coding device and the audio signal decoding device according to the embodiments described above are each implemented typically in an LSI (Large Scale Integration) which is an integrated circuit. These processing components may separately be mounted on one chip, or some or the whole of the processing components may be mounted on one chip.

Moreover, the integrated circuit is not limited to the LSI, and may be implemented in a dedicated circuit or a general-purpose processor. A field programmable gate array (FPGA) that can be programmed after manufacturing the LSI or a reconfigurable processor in which connection or settings of circuit cells in LSI is reconfigurable may be used.

Moreover, each component in each embodiment may take a form of dedicated hardware or may be implemented by executing a software program suitable for the component. Alternatively, the component may be implemented by a program execution unit, such as a CPU or processor, loading and executing the software program stored in a recording medium such as a hard disk or a semiconductor memory.

Furthermore, the present disclosure may be the above-described program or a non-transitory computer-readable storage medium having stored therein the program. Moreover, the program can, of course, be distributed via a transmission medium such as the Internet.

Moreover, at least some of the functionality of the audio signal coding device and audio signal decoding device according to the embodiments 1 and 2 and variations thereof may be combined.

Moreover, numerals used in the above are merely illustrative for specifically describing the present disclosure and the present disclosure is not limited thereto. The connection between the components is merely illustrative for specifically describing the present disclosure and connection implementing the functionality of the present disclosure is not limited thereto.

Moreover, the division of the functional blocks in the block diagrams is merely illustrative. A plurality of functional blocks may be implemented in one functional block, one functional block may be divided into plural, or some function of one functional block may be transferred to another. Similar function of a plurality of functional blocks may be processed in parallel or in a time sharing manner by a single piece of hardware or software.

Moreover, the order in which the steps included in the audio signal coding method and the audio signal decoding method is merely illustrative for specifically describing the present disclosure and may be different order. Some of the steps described above may be executed concurrently (in parallel) with other steps.

Furthermore, the present embodiments carried out in various ways that may be conceived by those skilled in the art are included in the present disclosure, without departing from the spirit of the present disclosure.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure is applicable to audio signal coding devices and audio signal decoding devices. The present disclosure is also suited for a transmitting device and a receiving device for an AV signal over a digital network.

1. An audio signal coding device comprising:
a layered coding unit configured to code a low-band signal in a first frequency band lower than a boundary frequency to generate a coded low-band signal, and code a high-band signal in a second frequency band higher than the boundary frequency to generate a coded high-band signal, the low-band signal and the high-band signal being included in an input audio signal;
a layer boundary setting unit configured to determine a coding bitrate to be used by the layered coding unit for coding the low-band signal and the high-band signal, set the boundary frequency to a first frequency if the coding bitrate is a first bitrate, and set the boundary frequency to a second frequency lower than the first frequency if the coding bitrate is a second bitrate lower than the first bitrate; and
a multiplexer unit configured to multiplex the coded low-band signal, the coded high-band signal, and boundary information indicative of the boundary frequency to generate a coded audio signal.

2. The audio signal coding device according to claim 1, wherein
the multiplexer unit is configured to multiplex the coded low-band signal and the coded high-band signal into the coded audio signal, in a manner that the coded low-band signal and the coded high-band signal are separatably allocated to respective regions of the coded audio signal.

3. The audio signal coding device according to claim 2, wherein
the multiplexer unit is further configured to transmit the coded audio signal to an audio signal decoding device through a transmission path,
the audio signal coding device further comprising a transmission capacity estimation unit configured to estimate a transmission capacity of the transmission path, wherein
the layer boundary setting unit is further configured to set the coding bitrate to the first bitrate if the transmission capacity is a first transmission capacity, set the coding bitrate to the second bitrate if the transmission capacity is a second transmission capacity less than the first transmission capacity, and determine the boundary frequency using the set coding bitrate.

4. The audio signal coding device according to claim 3, wherein
the transmission path includes a first layer and a second layer having a lower priority than the first layer, and a signal on the second layer is discarded if an amount of transmission of the transmission path exceeds a predetermined value, and
the multiplexer unit is configured to send the coded audio signal to the transmission path in a manner that the coded low-band signal is allocated to the first layer and the coded high-band signal is allocated to the second layer.

5. The audio signal coding device according to claim 4, further comprising:
an inter-channel correlation detection unit configured to detect a phase difference between channels of an N-channel audio signal and a ratio between levels of the channels to generate inter-channel correlation information indicative of the phase difference and the ratio between the levels, where N is an integer greater than 1; and
a downmix unit configured to downmix the N-channel audio signal into an M-channel signal to generate the input audio signal, where M is an integer greater than 0 and smaller than N, wherein
the multiplexer unit is configured to multiplex the coded low-band signal, the coded high-band signal, the boundary information, and the inter-channel correlation information to generate the coded audio signal and allocates the inter-channel correlation information to the second layer.

6. The audio signal coding device according to claim 1, wherein
the layer boundary setting unit is further configured to:
set the first frequency band to a first band and the second frequency band to a second band if the coding bitrate is the first bitrate; and
set the first frequency band to a third band narrower than the first band and the second frequency band to a fourth band narrower than the second band if the coding bitrate is the second bitrate.

7. An audio signal decoding device which decodes a coded audio signal which is obtained by coding an input audio signal using a layered coding scheme, the audio signal decoding device comprising:
a splitter unit configured to obtain, from the coded audio signal, a coded low-band signal obtained by coding a low-band signal in a first frequency band lower than a boundary frequency, a coded high-band signal obtained by coding a high-band signal in a second frequency band higher than the boundary frequency, and boundary information indicative of the boundary frequency, the low-band signal and the high-band signal being included in the input audio signal;
a low-band signal decoding unit configured to decode the coded low-band signal to generate a decoded low-band signal;
a high-band signal decoding unit configured to decode the coded high-band signal, according to the boundary information, to generate a decoded high-band signal; and
a combiner unit configured to combine the decoded low-band signal and the decoded high-band signal to generate a decoded audio signal, wherein
the combiner unit is configured to generate the decoded audio signal using the decoded low-band signal if the combiner unit fails to obtain the coded high-band signal.

8. The audio signal decoding device according to claim 7, wherein
the input audio signal is obtained by downmixing an N-channel audio signal having N channels into an M-channel signal, where N is an integer greater than 1 and M is an integer greater than 0 and less than N, and
the splitter unit is further configured to obtain, from the coded audio signal, inter-channel correlation information indicative of a phase difference between the N channels and a ratio between levels of the N channels,
the audio signal decoding device further comprising an upmix unit configured to upmix the decoded audio signal having M channels to a decoded audio signal having the N channels, using the inter-channel correlation information.
